(19) United States
(12) Patent Application Publication
(10) Pub. No.: US 2004/0044559 A1
(43) Pub. Date: Mar. 4, 2004

(54) System for taking interactive surveys of a user at a client display station through the dynamic generation of a sequence of linked hypertext documents built at the client display station

(75) Inventors: Nadeem Malik, Austin, TX (US); Lane Thomas Holloway, Pflugerville, TX (US)

Correspondence Address: Mark E. McBurney, International Business Machines Corporation, Intellectual Property Law Department, 11400 Burnet Road, Internal Zip 4054, Austin, TX, 78758, US

(73) Assignee: International Business Machines Corp., Armonk, NY

(21) Appl. No.: 10/232,245

(22) Filed: Aug. 29, 2002

(51) Int. Cl. G06F 17/60

(52) U.S. Cl. 705/10

(57) ABSTRACT

A method, system and program for conducting user surveys and electronic interviews that has greater flexibility in determining sets of questions to be generated, and does not require the downloading of a whole Java object oriented program at a client display station. An implementation for accessing and displaying at a client display station a hypertext document including a plurality of survey questions having user selectable answers, and for triggering, by at least one of said answers, a hyperlink to a dynamically generated hypertext document including a different plurality of questions also having user selectable answers. There also in an implementation for generating such a dynamically generated hypertext document. The survey and, consequently, the hypertext documents may be readily available from the World Wide Web or other network sources. The invention is preferably implemented through a World Wide Web browser at the client display station that includes both the accessing and displaying at a client display station of a hypertext document including a plurality of survey questions having user selectable answers, as well as the implementation for triggering, by at least one of said answers, a hyperlink to a dynamically generated hypertext document. The documents or pages used in the surveys are preferably dynamically generated HTML documents, such as DHTML that use scripting languages, such as Javasript in the generation of HTML pages.

### CROSS-REFERENCED COPENDING APPLICATIONS:

Method, Apparatus and Computer Program Product for Interactive Surveying, Ser. No. 09/925,585, filed Aug. 9, 2001; and Method, Apparatus and Computer Program Product for Technology Comparisons, Ser. No. 09/935,413, filed Aug. 23, 2001, both having the same inventors as and assigned to a common assignee of the present application.

### TECHNICAL FIELD

The present invention relates to a system, method and program for the conducting of interactive user surveys or interviews. These surveys may be conveniently distributed through computer networks such as the World Wide Web (Web) or Internet and use Hypertext Markup Language documents that are dynamically generated.

### BACKGROUND OF RELATED ART

The past decade has been marked by a technological revolution driven by the convergence of the data processing industry with the consumer electronics industry. The effect has driven technologies that have been known and available and relatively quiescent over the years. Two of these technologies are the Internet-related distribution and object oriented programming systems. Both of these technologies are embodied in the use of object oriented technology and the Java programming system in particular for a wide variety of consumer and business purposes over the Internet or Web. The computer and communications industries are extensively participating in the development and upgrading of Java or like object oriented programming that may be distributed over the Internet or Web or like private networks. For details and background with respect to the Java system, reference may be made to a typical text, Just Java, 2nd Edition, Peter van der Linden, Sun Microsystems, 1997. With the development and rapid expansion of the Web and other like networks, hypertext markup languages became the primary vehicle for distribution of data over such networks. A basic hypertext language, HTML, is described in detail in above-entitled Just Java text, particularly at Chapter 7, pp. 249-268, dealing with the handling of Web pages; and also in the text, Mastering the Internet, G. H. Cady et al., published by Sybex Inc., Alameda, Calif., 1996, particularly at pp. 637-642, on HTML in the formation of Web pages. The Web pages are implemented so as to be used for the distribution of Web documents containing text, images, both still and moving, and sound, as well as programs.

The rapid expansion of people, businesses and organizations with Web or Internet (used interchangeably) access, has resulted in the widespread use of the Web for business, e.g. e-business and like electronic business, educational, medical and legal transactions. This, in turn, has resulted in a marked reduction in the amount of personal contact involved in such networked business transactions. In many business, professional and personal relationships through the Web, interactive surveys or interviews have been used to acquaint the parties and their needs with each other. Through such surveys or electronic interviews, customers may learn about vendors, and vice versa; and doctors may learn at least the preliminaries about patients, for example. The cross-referenced copending applications are examples of methods of taking such surveys. These surveys are set up in a hierarchical structure wherein the answers that the user makes to one displayed set of questions will determine the branches to other predetermined sets of questions that may then be displayed. In these applications, the whole survey, including its hierarchy of branches to predetermined sets of questions, is sent as an object oriented program applet embedded in an HTML page or document to the client display station on which the survey is to be taken. While these surveys have proven to be effective logically branching surveys, they have limitations. In such surveys, the whole survey application must be downloaded as an applet on the client display station. Also, there is less flexibility in presenting only the essential questions to the user being surveyed or interviewed because only fixed sets of questions may be branched to.

### SUMMARY OF THE PRESENT INVENTION

The present invention offers an improved system that addresses the limitations of prior art surveys. The present invention may be effectively used in a network comprising database sources of hypertext documents. There is provided a system for taking interactive surveys of users at client display stations that comprises the combination of means for accessing and displaying at a client display station a hypertext document including a plurality of survey questions having user selectable answers, and means for triggering, by at least one of said answers, a hyperlink to a dynamically generated hypertext document including a different plurality of questions also having user selectable answers. There also are means for generating such a dynamically generated hypertext document. The survey and, consequently, the hypertext documents may be readily available from Web or other network sources. The invention is preferably implemented through a Web browser at the client display station that includes both the means for accessing and displaying at a client display station a hypertext document including a plurality of survey questions having user selectable answers, as well as the means for triggering by at least one of said answers a hyperlink to a dynamically generated hypertext document. The documents or pages used in the surveys are preferably dynamically generated HTML documents, such as DHTML, that use scripting languages, such as Javasript, in the generation of HTML pages.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view of a network portion, to illustrate how the survey of the present invention with dynamically triggered Web pages may be carried out via a local network of a server computer connected to a Web portion;

FIG. 2 is a block diagram of a data processing system including a central processing unit and network connections via a communications adapter that is capable of functioning both as a server computer and a client display station;

FIG. 3 is an illustrative interactive display showing an illustrative initial DHTML supported page of survey questions with potential hyperlinks to trigger the dynamic generation of a subsequent DHTML page with appropriate selective subsequent questions;

FIG. 4 is an illustrative display page like that of FIG. 3 showing a DHTML supported page of survey questions generated in response to the triggering of hyperlinks in the page shown in FIG. 3;

FIG. 5 is an illustrative flowchart describing the setting up of the elements of the present invention for the dynamic generation of HTML supported displayed pages of survey questions in response to the triggering of hyperlinks in previous displayed survey questions; and

FIG. 6 is a flowchart of an illustrative run of the program set up in FIG. 5.

### DETAILED DESCRIPTION OF THE PREFERRED EMBODIMENT

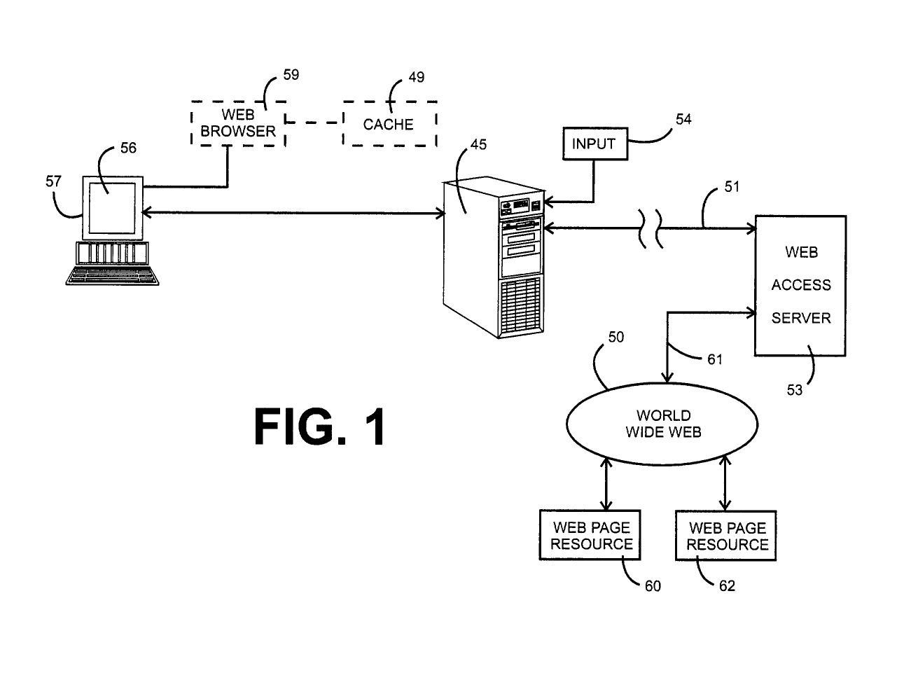

Referring to FIG. 1, there is shown a very generalized diagram of a Web portion on which the present invention may be implemented. In the examples that follow, we will use the Web as the computer controlled object oriented programming network system. Actually, the present invention may be implemented on any appropriate network for handling object oriented program systems. The Web is the convenient medium of distribution for the interactive surveys being run. Also, Web or like network functions are most likely to find the surveys useful. The customer network on which the surveys are to be distributed is illustrated by server computer 45 connected to and serving client computers 57, having a user interactive display interface 58, controlled by a conventional Web browser program 59 and an associated cache 49. Server 45 is typically connected to the Web 50 via standard Web wired connections through Web access server 53 that may be provided by a commercial service provider via connections 61. Reference may be made to the text, Mastering the Internet, G. H. Cady et al., published by Sybex Inc., Alameda, Calif., 1996, particularly pp. 136-147, for typical connections between local display stations to the Web 50 via access server 53 through connection 51.

The HTML Web pages used to transmit the survey may originate at Web page resource sites 60 or 62 and be transmitted over the Web to client server 45 on which the Web page or document is stored until the client computers select to take the survey. This would be the case if the relationship between the surveyor and surveyee is such that the surveyee or user takes the survey on a regular basis. If the user takes the survey infrequently, then the survey may be stored at the Web sites 60 and 62 until the user requests the survey. Alternatively, the Web documents may be input for storage in server 45 through I/O 54 by any other convenient input expedient. In any event, the Web documents remain stored on server 45 until the client computer 57 accesses and displays the interactive dynamic Web document, as will be subsequently described.

Before going further into the details of specific embodiments, it will be helpful to understand from a more general perspective the various elements and methods that may be related to the present invention. Since an aspect of the present invention is directed to Web documents, such as Web pages, transmitted over networks, an understanding of networks and their operating principles would be helpful. We will not go into great detail in describing the networks to which the present invention is applicable. The Internet or Web is a global network of a heterogeneous mix of computer technologies and operating systems. Objects are linked to other objects in the hierarchy through a variety of network server computers. These network servers are the key to network distribution, such as the distribution of Web pages and related documentation. In this connection, the term “documents” is used to describe data transmitted over the Web or other networks and is intended to include Web pages with displayable text, graphics and other images.

Web documents are conventionally implemented in HTML language, which is described in detail in the above-referenced text entitled Just Java, particularly at Chapter 7, pp. 249-268, dealing with the handling of Web pages; and also in the aforementioned text Mastering the Internet, particularly at pp. 637-642, on HTML in the formation of Web pages.

In addition, aspects of this invention will involve Web browsers. A general and comprehensive description of browsers may be found in the above-mentioned Mastering the Internet text at pp. 291-313. More detailed browser descriptions may be found in the Internet: The Complete Reference, Millennium Edition text mentioned above: Chapter 19, pp. 419-454, on the Netscape Navigator; Chapter 20, pp. 455-494, on the Microsoft Internet Explorer; and Chapter 21, pp. 495-512, covering Lynx, Opera and other browsers.

The surveys of the present invention are implemented using the Java Programming system, which is an object oriented system utilizing the Java programming language. The Java system and language are extensively familiar to those skilled in the art. The text Just Java, that was described above, comprehensively details the system and language. Nonetheless, it should be helpful to generally review the known principles of object oriented programming. It should be understood by those skilled in the art that object oriented programming techniques involve the definition, creation, use and instruction of “objects”. These objects are software entities comprising data elements or attributes and methods that manipulate the data elements. The data and related methods are treated by the software as an entity and can be created, used and deleted as such. The data and functions enable objects to model their real world equivalent entity in terms of its attributes, which can be presented by the data elements, and its behavior, which can be represented by its methods.

The survey that is distributed or input to server 45 is in the form of a Java program servelet written in the XML (Extensive Markup Language) language. These Java servelets are executable programs designed to be run on servers that are distributable over the Web. For further details on servelets, the above-referenced text, Just Java, particularly pp. 348-349, may be consulted.

With respect to the XML in which the survey is written, unlike HTML, its markup tags are not fixed or predefined sets; XML tags are extensible on a case-by-case basis. The protocols of XML are established and maintained by the W3C organization (World Wide Web Consortium-Web site: www.w3.org). In general, XML has a hierarchical data format whereby data elements may be nested within other data elements and have their associated attributes. Thus, the present XML survey file contains an extensive set of questions and their potential answers as strings of text surrounded by text markups, including tags that define the data elements and attributes that define associations, question answers and/or sets of answers may be used to trigger the dynamic forming of new subsets of questions in dynamically HTML generated pages to be presented to client users, as will be subsequently described.

These dynamically generated pages are formed through DHTML functions performed by the Java servelets at servers 45 through the selective parsing of the received XML survey files into JavaScript language files that are then selectively added to the HTML that will provide the displayed dynamically generated survey screen presented to the user taking the survey on display 56.

The general functions and protocols of DHTML are described in detail in the text, Dynamic HTML in Action, Michele Petrovsky, published 1998, Osborne/McGraw-Hill, Berkeley, Calif. Scripting, e.g. via JavaScript, which refers to the ability of Dynamic HTML to add command files or scripts through which HTML supporting the individual display screens may be augmented with embedded objects. This may be done in response to triggering events. The functioning of JavaScript in this regard is described in this textbook, particularly at pp. 100, 1845 and 354-359.

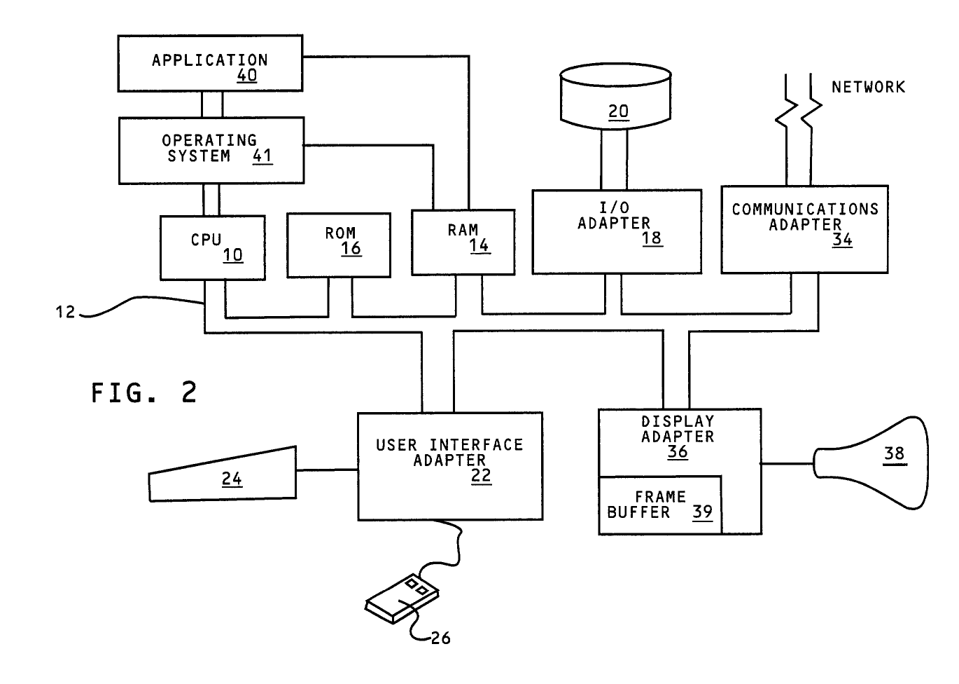

Referring to FIG. 2, a typical data processing unit is shown that may function as the client computer 57 used for receiving the Web page screens for the survey or function as the server computers 45 (FIG. 1). A central processing unit (CPU) 10, such as one of the PC microprocessors or workstations, e.g. eServer pSeries available from International Business Machines Corporation (IBM) or Dell PC microprocessors, is provided and interconnected to various other components by system bus 12. An operating system 41 runs on CPU 10, provides control and is used to coordinate the function of the various components of the computer of FIG. 2. Operating system 41 may be one of the commercially available operating systems, such as IBM's AIX or Microsoft's WindowsMe™ or Windows 2000™, as well as UNIX and other IBM AIX operating systems. Application programs 40, controlled by the system, are moved into and out of the main memory Random Access Memory (RAM) 14. These programs include the object oriented servelet programs on server 45 for the dynamic generation of HTML display pages on client screen 56. These functions will be described hereinafter in combination with conventional Web browsers (browsers 49, FIG. 1) at client computers, such as Netscape 4.76™ or Microsoft's Internet Explorer™. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. The Web browser cache (cache 49, FIG. 1) may be set up on disk storage 20. Communications adapter 34 interconnects bus 12 with an outside network. In the server 45, this could be the Web. I/O devices are also connected to system bus 12 via user interface adapter 22 and display adapter 36. Keyboard 24 and mouse 26 are all interconnected to bus 12 through user interface adapter 22. It is through such input devices that the user at the client computers may interactively relate to the Web server programs for taking the survey.

Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

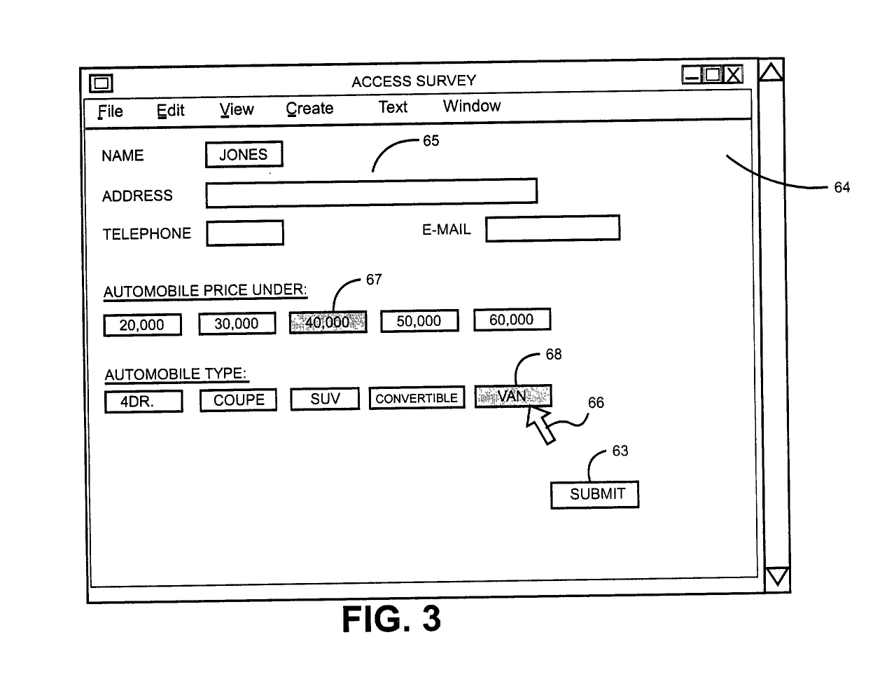

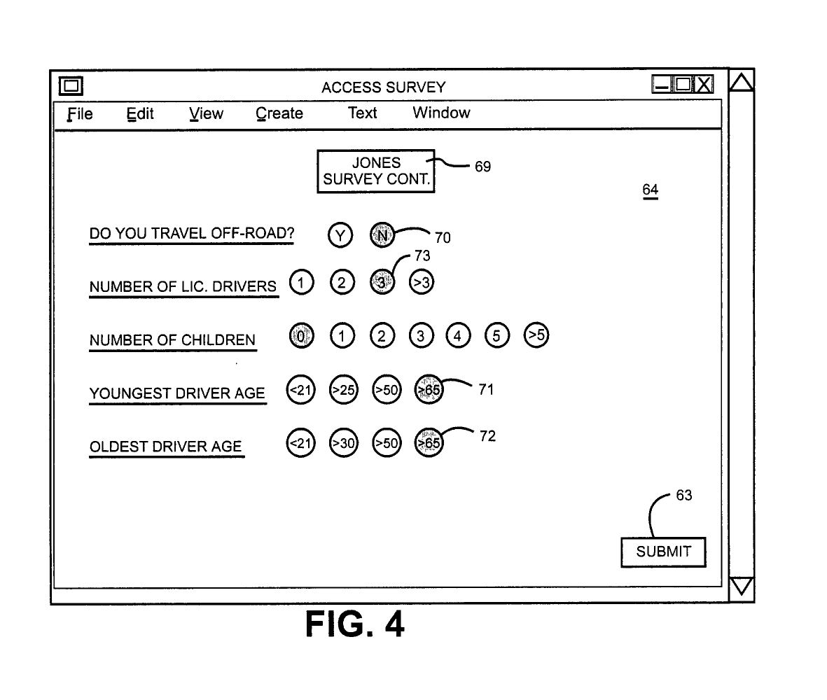

Now, with respect to FIGS. 3 and 4, we will provide an illustrative example of how the present invention may be used to take user interactive surveys of dynamically generated HTML display screens. FIG. 3 shows a typical initial HTML page presented to a user taking a survey at the interactive display 56 of a client computer 57 provided by the Java Servelet programs stored on client server computer 45 (FIG. 1). The display screen or page 64 provides an interactive dialog that solicits general information 65, and then particular questions as to automobile price for which the user has selected answer 67, and automobile type for which the user has selected answer 68. The answers are tracked and stored through server 45. In this example, the combination of answers 67 and 68 constitute the combination of events that trigger object oriented Java Servelet on server 45 to dynamically generate a new HTML survey screen that is shown in FIG. 4. It should be understood that the survey process has been simplified for purposes of illustration. In an actual embodiment, the displayed screen 64 may have already been scrolled through a sequence of questions wherein a combination of answers have been noted and stored. In such a case, the selection of answer 68 by a click of cursor 66 may have been the last event that triggers the creation of the dynamically generated page of questions shown in FIG. 4. Thus, answer 68 is the hyperlink that, when clicked on, results in the access from server 45 and the display on client computer 57 (FIG. 1) of the new HTML page of survey questions shown in FIG. 4.

The page 64 of FIG. 4 identifies the continuing survey 69 and goes on to solicit a series of answers 70-73 to a new set of questions. Here again, any one of the answers 70-73 may act as the selected hyperlink to the dynamic generation of the next HTML page of questions. Alternatively, in both FIGS. 3 and 4, the interactive display survey may be set up so that no link is triggered until the user pushes the “Submit” button 63. At such a time, the process would determine whether the triggering link to dynamically generate the next page has been selected.

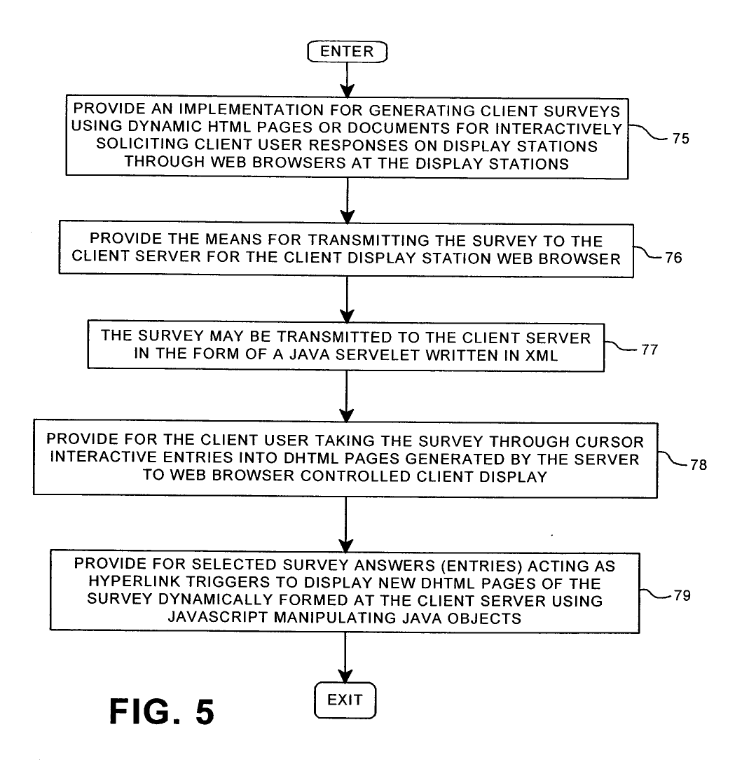

FIG. 5 is a flowchart showing the development of a process according to the present invention for the dynamic generation of subsequent HTML pages in a survey in response to the triggering of a hyperlink to the subsequent page responsive to selection of answers in the previous page. Step 75, an implementation is provided for generating client surveys using dynamic HTML pages for interactively soliciting client user responses on display stations through Web browsers at the display stations. Web means are provided for transmitting the survey to the client server for the display station Web browser on which the survey will be conducted, step 76. The survey is conveniently transmitted to the server in the form of a Java Servelet written in XML, step 77. Provision is made for the client user to take the survey through cursor interactive entries into DHTML pages generated by the server to the Web browser controlled by the client display computer, step 78. Provision is made for selected survey answers acting as triggers to display new DHTML pages of the survey dynamically formed at the client server using JavaScript manipulated Java objects, step 79.

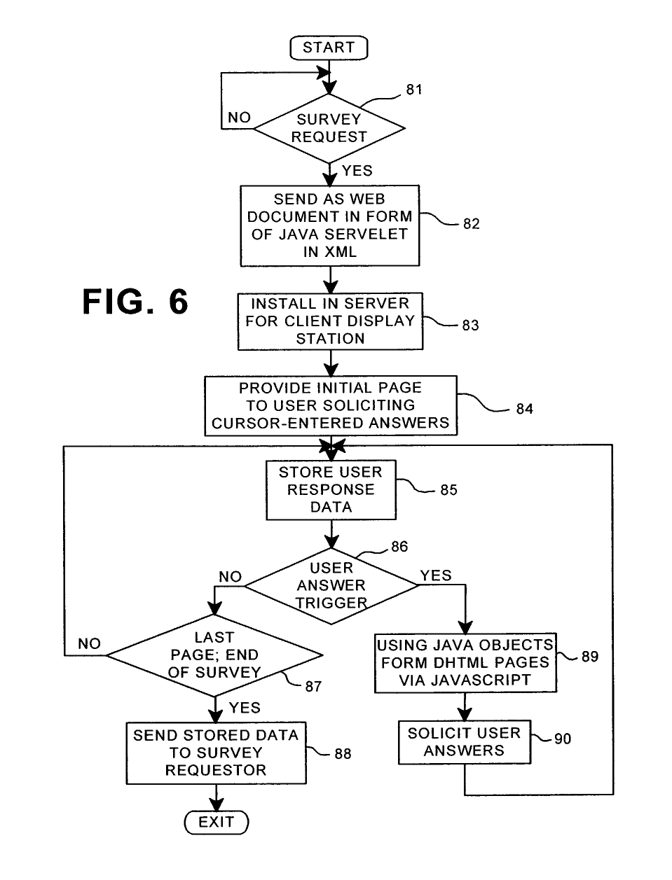

The running of the process set up in FIG. 5 will now be described with respect to the flowchart of FIG. 6. An initial determination is made as to whether the user has requested or been requested to take the survey, step 81. If No, the process is returned to step 81 where such a request is awaited. If Yes, and the survey application is not as yet stored in association with server 45, (FIG. 1), it is sent as an XML Web document including a Java Servelet to server 45, step 82, and installed therein, step 83. An initial survey HTML page (FIG. 3) is sent to client 57 (FIG. 1), step 84, and the user response data is stored in association with server 45, step 85. Then a determination is made as to whether any user answer or combination of answers has triggered the dynamic generation of a new HTML page of questions, step 86. If Yes, then, step 87, using the Java objects in the servelet, a new HTML page of questions is generated using the JavaScript, step 89, the user answers are solicited in an interactive dialog, step 90, and the process is branched back to step 85. If there are no such triggering answers as determined is step 86, the survey is continued, step 85, until it is determined, step 87, Yes the end of the survey has been reached, i.e. the survey is completed. Then, step 88, the survey data stored at the server 45 is sent to the requester of the survey and the process is exited.

One of the preferred implementations of the present invention is in application program 40, i.e. a browser program made up of programming steps or instructions resident in RAM 14, FIG. 2, of a client display station and/or server during various operations. Until required by the computer system, the program instructions may be stored in another readable medium, e.g. in disk drive 20 or in a removable memory, such as an optical disk for use in a CD ROM computer input or in a floppy disk for use in a floppy disk drive computer input. Further, the program instructions may be stored in the memory of another computer prior to use in the system of the present invention and transmitted network such as the Web itself, when required by the user of the present invention.

One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. In a network comprising database sources of hypertext documents each having hyperlinks to other hypertext elements, a system for taking interactive surveys of users at client display stations comprising:
means for accessing and displaying at a client display station a hypertext document including a plurality of survey questions having user selectable answers; and
means for triggering by at least one of said answers a hyperlink to a dynamically generated hypertext document including a different plurality of questions also having user selectable answers.

2. The system for taking interactive surveys of claim 1 further including means for generating said dynamically generated hypertext document.

3. The system for taking interactive surveys, of claim 2 further including means for storing said user survey answers selected at the client display station.

4. The system for taking interactive surveys of claim 2 wherein said hypertext document is a World Wide Web document from a source on the World Wide Web.

5. The system for taking interactive surveys of claim 4 further including:
a World Wide Web browser at said client display station, said World Wide Web browser including:
said means for accessing and displaying at a client display station a hypertext document including a plurality of survey-questions having user selectable answers; and
said means for triggering by at least one of said answers a hyperlink to a dynamically generated hypertext document.

6. The system for taking interactive surveys of claim 5 wherein said hypertext documents are hypertext markup language documents.

7. The system for taking interactive surveys of claim 6 wherein said hypertext markup language documents are DHTML documents.

8. The system for taking interactive surveys of claim 7 wherein said means for generating said dynamically generated hypertext document uses a scripting language.

9. The system for taking interactive surveys of claim 8 wherein said scripting language is JavaScript.

10. The system for taking interactive surveys of claim 9 further including client servers for accessing said surveys from World Wide Web sites for said client stations.

11. The system for taking interactive surveys of claim 10 wherein said surveys are transmitted from World Wide Web sites to said client servers as Java Servelets written in XML.

12. In a network comprising database sources of hypertext documents each having hyperlinks to other hypertext elements, a method for taking interactive surveys of users at client display stations comprising:
accessing and displaying at a client display station a hypertext document including a plurality of survey questions having user selectable answers; and
triggering by at least one of said answers a hyperlink to a dynamically generated hypertext document including a different plurality of questions also having user selectable answers.

13. The method of taking interactive surveys of claim 12 further including the step of generating said dynamically generated hypertext document.

14. The method of taking interactive surveys of claim 13 further including the step of storing said survey answers selected by the client display station.

15. The method of taking interactive surveys of claim 13 wherein said hypertext document is a World Wide Web document from a source on the World Wide Web.

16. The method of taking interactive surveys of claim 15 further including:
a World Wide Web browsing method at said client display station including said steps of accessing and displaying at a client display station a hypertext document including a plurality of survey questions having user selectable answers; and
triggering by at least one of said answers a hyperlink to a dynamically generated hypertext document.

17. The method of taking interactive surveys of claim 16 wherein said hypertext documents are hypertext markup language documents.

18. The method of taking interactive surveys of claim 17 wherein said hypertext markup language documents are DHTML documents.

19. The method of taking interactive surveys of claim 18 wherein said step of generating said dynamically generated hypertext document uses a scripting language.

20. The method of taking interactive surveys of claim 19 wherein said scripting language is JavaScript.

21. The method of taking interactive surveys of claim 20 wherein said surveys are accessed from World Wide Web sites by servers serving said client stations.

22. The method of taking interactive surveys of claim 10 wherein said surveys are transmitted from said World Wide Web sites to said servers as Java Servelets written in XML.

23. A computer program having code recorded on a computer readable medium for taking an interactive survey of a user at a client display station in a network comprising database sources of hypertext documents each having hyperlinks to other hypertext elements comprising:
means for accessing and displaying at a client display station a hypertext document including a plurality of survey questions having user selectable answers; and
means for triggering by at least one of said answers a hyperlink to a dynamically generated hypertext document including a different plurality of questions also having user selectable answers.

24. The computer program for taking interactive surveys of claim 23 further including means for generating said dynamically generated hypertext document.

25. The computer program for taking interactive surveys of claim 23 further including means at the client display station for storing said user selectable answers at the client display station.

26. The computer program for taking interactive surveys of claim 24 wherein said hypertext document is a World Wide Web document from a source on the World Wide Web.

27. The computer program for taking interactive surveys of claim 26 further including:
a World Wide Web browser program at said client display station, said World Wide Web browser program including:
said means for accessing and displaying at a client display station a hypertext document including a plurality of survey questions having user selectable answers; and
said means for triggering by at least one of said answers a hyperlink to a dynamically generated hypertext document.

28. The computer program for taking interactive surveys of claim 27 wherein said hypertext documents are hypertext markup language documents..

29. The computer program for taking interactive surveys of claim 28 wherein said hypertext markup language documents are DHTML documents.

30. The computer program for taking interactive surveys of claim 29 wherein said means for generating said dynamically generated hypertext document uses a scripting language.

31. The computer program for taking interactive surveys of claim 30 wherein said scripting language is JavaScript.

32. The computer program for taking interactive surveys of claim 31 further including client servers for accessing said surveys from World Wide Web sites for said client stations.

33. The computer program for taking interactive surveys of claim 32 wherein said surveys are transmitted from said World Wide Web sites to said client servers as Java Servelets written in XML.

34. In a network comprising database sources of hypertext documents each having hyperlinks to other hypertext elements, a system for taking interactive surveys of users at client display stations comprising:
a processor device for accessing and displaying at a client display station a hypertext document including a plurality of survey questions having user selectable answers; and
an implementation for triggering by at least one of said answers a hyperlink to a dynamically generated hypertext document including a different plurality of questions also having user selectable answers.

35. The system for taking interactive surveys of claim 34 further including a device for generating said dynamically generated hypertext document.

36. The system for taking interactive surveys of claim 35 wherein said hypertext document is a World Wide Web document from a source on the World Wide Web.

37. The system for taking interactive surveys of claim 36 further including:
a World Wide Web browser device at said client display station, said World Wide Web browser including:
said means for accessing and displaying at a client display station a hypertext document including a plurality of survey questions having user selectable answers; and
said means for triggering by at least one of said answers a hyperlink to a dynamically generated hypertext document.

38. The system for taking interactive surveys of claim 37 wherein said hypertext documents are hypertext markup language documents.

39. The system for taking interactive surveys of claim 38 wherein said hypertext markup language documents are DHTML documents.

40. The system for taking interactive surveys of claim 39 wherein said device for generating said dynamically generated hypertext document uses a scripting language.

41. The system for taking interactive surveys of claim 40 wherein said scripting language is JavaScript.

42. The system for taking interactive surveys of claim 41 further including client servers for accessing said surveys from World Wide Web sites for said client stations.
